(19) United States
(12) Patent Application Publication
(10) Pub. No.: US 2013/0175398 A1
(43) Pub. Date: Jul. 11, 2013

(54) Airplane parachute

(71) Applicant: Daniel C. Chia, Alhambra, CA (US)

(72) Inventor: Daniel C. Chia, Alhambra, CA (US)

(21) Appl. No.: 13/374,686

(22) Filed: Jan. 9, 2012

(51) Int. Cl. B64D 17/80

(52) U.S. Cl. 244/139

(57) ABSTRACT

An improved airplane safety system which does not require wearing of individual parachutes and does not reduce the cabin space available for passengers, luggage, cargo, etc., yet which enables the entire airplane to be safely lowered to the ground when an emergency occurs said system comprising plurality of parachutes mounted at the center of the airplane body and adjacent the wing tips and the front and rear of the fuselage which, when activated, deploy simultaneously or individually, as desired, to enable the entire airplane to float safely down to a soft and safe landing or to provide additional speed or directional controls.

### RELATED CASES

This invention is described in my copending Provisional Application Ser. No. 60/764,814, filed Feb. 3, 2006 and now ______.

### FIELD OF INVENTION

This invention relates to aircraft and is particularly directed to improved aircraft having built-in parachutes to allow safe landings in the event of accidents during flight.

### PRIOR ART

As is well known, airplanes occasionally encounter rough weather, air turbulence or other conditions which can cause an airplane to crash. Also, fires or other mechanical failures can also cause crashes. Parachutes have been available for years to enable individuals to safely escape such conditions. However, individual parachutes are bulky and uncomfortable to wear. Therefore, with modem airplanes, it is common for pilots or passengers not to wear parachutes. Also, under emergency conditions, the pilot and passengers are often distracted and, even if parachutes are available, the occupants of the airplane may forget or be unable to access the parachutes or to put them on. It has been also proposed heretofore to provide a single parachute for the entire airplane which would be housed in the fuselage and could be released to carry the entire airplane safely to the ground. Unfortunately, this requires a parachute of large dimensions, which is difficult to house in the limited area of an airplane cabin and significantly restricts the space available for passengers, luggage and the like. Furthermore, the provision of a single parachute serves to lower the airplane, but makes no provision for speed control or directional control Thus, none of the prior art safety devices have been entirely satisfactory.

### BRIEF SUMMARY AND OBJECTS OF INVENTION

These disadvantages of the prior art are overcome with the present invention and an improved safety system is provided which does not require the use of individual parachutes and which do not effect the cabin space available for passengers, cargo etc., yet which enables the entire airplane to be safely lowered to the ground when an emergency occurs and also provides speed and directional controls.

These advantages of the present invention are preferably attained by providing a plurality of parachutes mounted on the center of the airplane body and adjacent the wing tips and the front and rear of the fuselage which, when activated, deploy simultaneously or individually, as desired, to enable the entire airplane to float safely down to a soft and safe landing or to provide additional speed and directional controls/

Accordingly, it is an object of the present invention to provide an improved airplane safety system.

Another object of the present invention is to provide an improved airplane safety system which does not require the wearing of individual parachutes.

An additional object of the present invention is to provide an improved airplane safety system which does not require the wearing of individual parachutes and which does not reduce the cabin space available for passengers, luggage, cargo, etc.

A further object of the present invention is to provide an improved airplane safety system which does not require wearing of individual parachutes and does not reduce the cabin space available for passengers, luggage, cargo, etc., yet which enables the entire airplane to be safely lowered to the ground when an emergency occurs.

Another object of the present invention is to provide an improved airplane safety system comprising a plurality of parachutes which may be deployed simultaneously or individually, as desired, to provide additional speed and directional controls.

A specific object of the present invention is to provide an improved airplane safety system which does not require wearing of individual parachutes and does not reduce the cabin space available for passengers, luggage, cargo, etc., yet which enables the entire airplane to be safely lowered to the ground when an emergency occurs, said system comprising plurality of parachutes mounted on the center of the airplane body and adjacent the wing tips and the front and rear of the fuselage which, when activated, deploy simultaneously or individually, as desired, to enable the entire airplane to float safely down to a soft and safe landing or to provide additional speed or directional controls.

These and other objects and features of the present invention will be apparent from the following detailed description, taken with reference to the figures of the accompanying drawing.

### BRIEF DESCRIPTION OF THE DRAWING

FIG. 1 is a diagrammatic plan view of an airplane embodying the present invention, showing the parachutes in their stowed positions; and

FIG. 2 is a diagrammatic oblique view of the airplane of FIG. 1, showing the parachutes deployed.

### DETAILED DESCRIPTION OF THE INVENTION

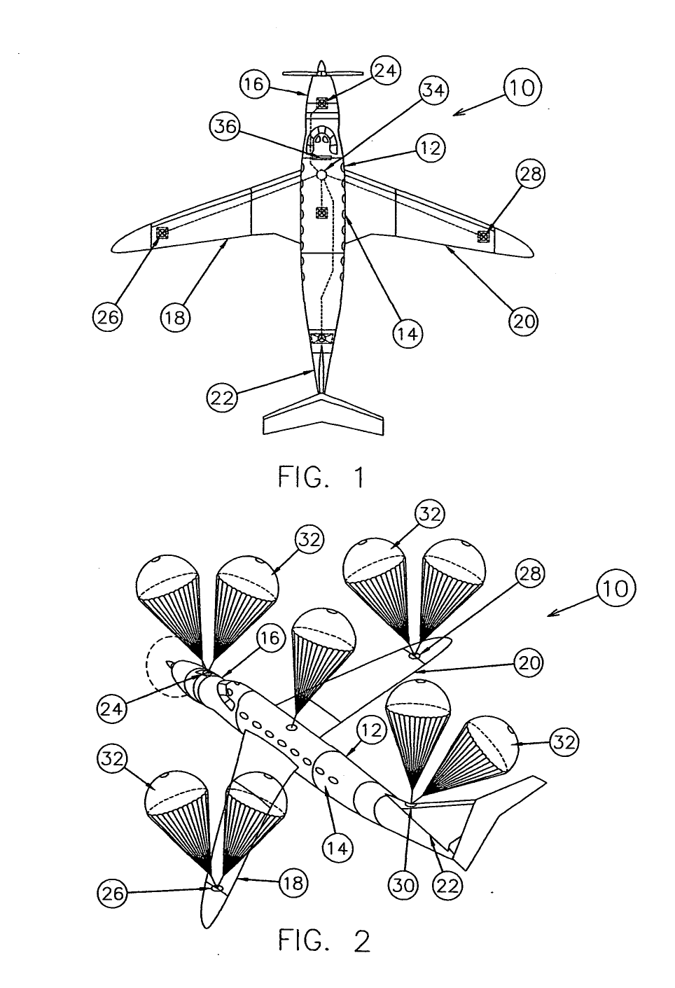

In that form of the present invention chosen for purposes of illustration, FIG. 1 shows an airplane, indicated generally at 10, a fuselage 12 with a cabin portion 14, an engine compartment 16, wings 18 and 20 and a tail section 22. At the front of the fuselage 12 forward of the engine compartment 16 a compartment 24 is provided for storing a plurality of parachutes, as seen at 32 in FIG. 2 Similar compartments 26 and 28 are provided adjacent the wing tips 18 and 20, a fourth compartment 30 is provided just forward of the tail section 22, while a fifth compartment 31 is located at the center of the airplane body 12 and contains a large parachute for lowering the airplane 10. The compartments 24, 26, 28, 30 and 31 are covered by hatches which open, when the parachutes 32 are activated, to allow deployment of the parachutes 32. The parachutes 32 are activated individually or simultaneously, as desired, by release levers 34 located on the control panel 36 of the airplane 10.

In use, the parachutes 32 are normally stowed in the compartments 24, 26, 28, 30 and 31. It should be noticed that the location of the parachute compartments 24, 26, 28, 30 and 31 are outside of the cabin portion 14 on the airplane 10 and, hence, will not reduce the space available for passengers, cargo and crew. when the pilot senses an emergency, he actuates the parachutes 32 by pressing the appropriate button or buttons on the release lever 34. This causes the hatch covers on compartments 24. 26, 28, 30 and 31 to open and releases the parachutes 32 for deployment. Preferably, each of the parachutes in the compartments 24, 26, 28 and 30 is sized so to support approximately one third of the weight of the airplane 12 at maximum weight. Thus, if something should occur to prevent any one of the parachutes 32 from opening, but the other three of the parachutes 32 open properly, the airplane 10 will be carried to a hard, but survivable landing. If all five of the parachutes open properly, the airplane 10 will be carried to a relatively soft landing. Consequently, in either case, the passengers, cargo and crew will be carried safely to the ground. If desired, the compartments 24, 26, 28, 30 and 31 may be provided with individual release levers 34 to enable the pilot to actuate a desired one or more of the parachutes 32, rather than to release all four simultaneously. Thus, for example, if the airplane 10 has retractable landing gear, which fail to deploy, the pilot could activate one or more of the parachutes 32 stored in the tail compartment 30. This drag would cause the airplane to fly in a nose up attitude. Since the fuel tanks are usually located in the wings, this would serve, on landing, allow the tail to engage the ground first and the resulting drag would slow the airplane considerably before the wings hit the ground, thereby greatly reducing the chance of fire. Also, in flight, releasing the parachutes 32 from the tail compartment 30 would serve to significantly reduce the speed of the airplane 10 to possibly avoid a collision. Similarly, if sudden directional changes are needed, the pilot can selectively release one or more of the parachutes 32 in the wing compartments 26 or 28 to cause the airplane 10 to suddenly swerve in the desired direction.

Obviously, numerous variations and modifications can be made without departing from the spirit of the present invention. therefore, it should be clearly understood that the forms of the present invention described above and shown in the figures of the accompanying drawing are illustrative only and are not intended to limit the scope of the present invention.

What is claimed is:

1. An airplane comprising:
a fuselage having a plurality of compartments located outside the cabin portion thereof, and
parachutes stowed in each of said compartments and releasable by the pilot to carry the airplane safely to the ground.

2. The airplane of claim 1 wherein:
said compartments are located forward of the engine, adjacent the wing tips, forward of the tail section of said fuselage and at the center of to airplane fuselage.

3. The airplane of claim 1 wherein:
said parachutes are sized so that any three thereof can carry said airplane to a hard, yet survivable landing.

4. The airplane of claim 1 wherein:
said parachutes are deployed by a lever on the pilot's control panel.

5. The airplane of claim 4 wherein:
the pilot can selectively actuate said parachutes.
